(19) United States
(12) Patent Application Publication
(10) Pub. No.: US 2012/0169549 A1
(43) Pub. Date: Jul. 5, 2012

(54) ANTENNA MODULE AND PORTABLE ELECTRONIC DEVICE USING THE SAME

(75) Inventors: CHIA-JU LIN, Tu-Cheng (TW); MIN-SHENG WANG, Tu-Cheng (TW); PEN-UEI LU, Tu-Cheng (TW); CHENG-YI CHEN, Tu-Cheng (TW)

(73) Assignee: CHI MEI COMMUNICATION SYSTEMS, INC., Tu-Cheng (TW)

(21) Appl. No.: 13/176,347

(22) Filed: Jul. 5, 2011

(30) Foreign Application Priority Data
Dec. 31, 2010 (TW) 99147411

(51) Int. Cl. H01Q 1/24

(52) U.S. Cl. 343/702

(57) ABSTRACT

A portable electronic device includes a housing and an antenna module detachably assembled to the housing. The housing defines at least one latching hole. The antenna module includes a base and an antenna attached to the base. The base includes at least one latching member. The base is received in the housing. The at least one latching member engages with the at least one latching hole to detachably assemble the base and the antenna to the housing.

### BACKGROUND

1. Technical Field

The disclosure generally relates to portable electronic devices, and particularly to a portable electronic device having a detachable antenna module.

2. Description of Related Art

Many portable electronic devices, such as mobile phones and personal digital assistants, include a housing, a motherboard located within the housing, and an antenna. The antenna is electrically connected to the motherboard, and is generally installed on the housing by surface mounted technology (SMT), which is complicated and costly. Moreover, since the antenna is fixed on the housing by SMT, it is difficult to repair or replace.

Therefore, there is room for improvement within the art.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment.

FIG. 1 is a schematic exploded view of a portable electronic device, according to an exemplary embodiment.

FIG. 2 is similar to FIG. 1, but showing the portable electronic device of FIG. 1 in another aspect.

FIG. 3 is an assembled view of the portable electronic device of FIG. 1.

FIG. 4 is similar to FIG. 3, but showing the assembled portable electronic device of FIG. 3 in another aspect.

### DETAILED DESCRIPTION

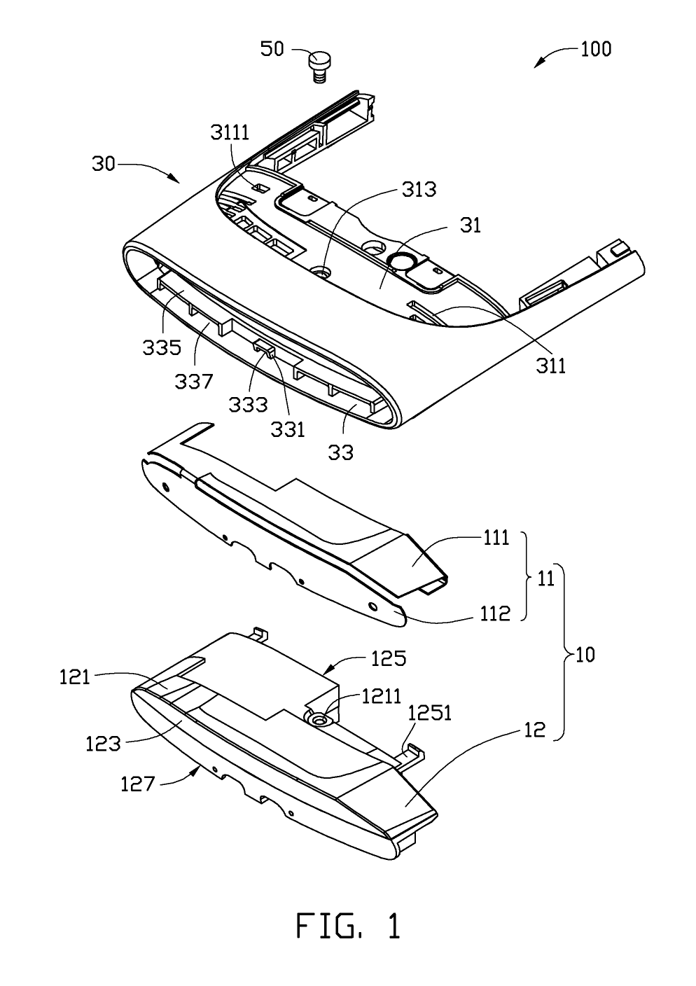

FIG. 1 shows a schematic exploded view of a portable electronic device 100, according to an exemplary embodiment. The portable electronic device 100 can be a mobile phone or a personal digital assistant, and the mobile phone is taken here as an example to illustrate the disclosure.

The portable electronic device 100 includes an antenna module 10, a housing 30 and at least one fastener, such as a screw 50. The antenna module 10 is fixedly assembled to the housing 30 with the screw 50.

The antenna module 10 includes an antenna 11 and a base 12. The antenna 11 is attached to the base 12. The antenna 11 includes a first radiating portion 111, and a second radiating portion 112 connected to the first radiating portion 111.

The base 12 includes a first mounting surface 121, a second mounting surface 123, a third mounting surface 125 opposite to the second mounting surface 123, and a fourth mounting surface 127 opposite to the first mounting surface 121. A screw hole 1211 is defined in the first mounting surface 121. The second mounting surface 123 is perpendicularly connected to the first mounting surface 121. The first mounting surface 121 and the second mounting surface 123 are respectively corresponding to the first radiating portion 111 and the second radiating portion 112. The first radiating portion 111 can be attached to the first mounting surface 121. The second radiating portion 112 can be attached to the second mounting surface 123.

In other embodiments, when the shape and size of the antenna 11 is changed, the shape and size of the first mounting surface 121 and the second mounting surface 123 can be accordingly adjusted to make the base 12 suitable for the antenna 11.

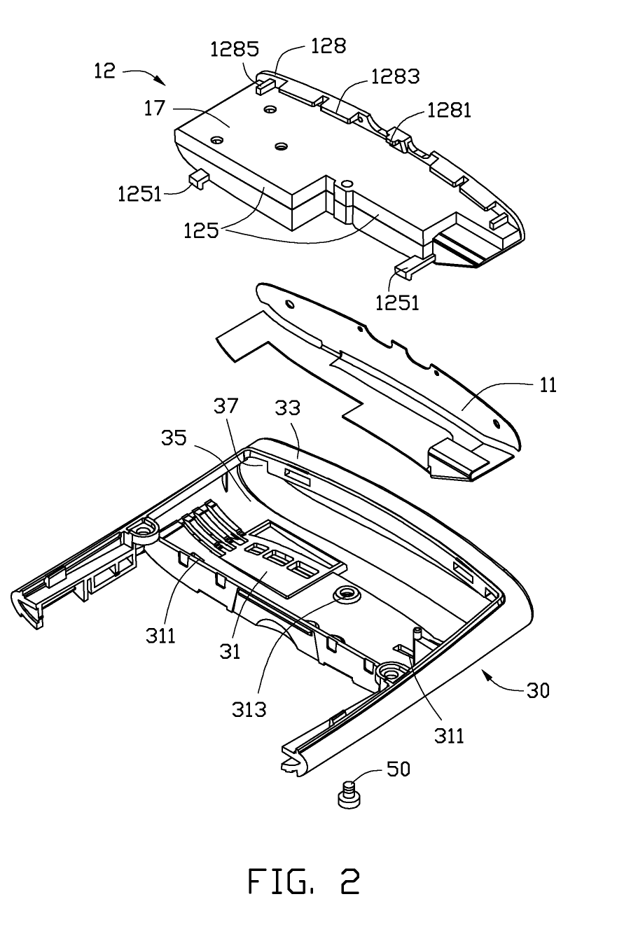

Also referring to FIG. 2, a plurality of latching members 1251 protrude from the third mounting surface 125. In this embodiment, the latching members 1251 are substantially L-shaped hooks. An extending wall 128 perpendicularly extends up from the fourth mounting surface 127. A first protruding block 1281 protrudes from a middle portion of the extending wall 128. Four second protruding blocks 1283 protrude from the extending wall 128 at two sides of the first protruding blocks 1281. Two guiding posts 1285 protrude from two ends of the extending wall 128.

In this exemplary embodiment, the housing 30 can be a part of cover of the mobile phone 100. The housing 30 includes a bottom wall 31 and an end portion 33 opposite to the bottom wall 31. The bottom wall 31 defines a recess that forms a receiving portion 35 for the antenna module 10. An opening 37 is formed between the bottom wall 31 and the end portion 33. Two latching holes 311 are defined in the bottom wall 31 corresponding to the latching members 1251. A through hole 313 is defined in the bottom wall 31 corresponding to the screw hole 1211.

Referring to FIG. 1 again, a U-shaped first protrusion 331 protrudes from the end portion 313 and forms a first latching slot 333. The first latching slot 333 is corresponding to the first protruding block 1281. Two M-shaped second protrusions 335 protrude from the end portion 33 at two sides of the first protrusion 335. Four second latching slots 337 are formed corresponding to the second protruding blocks 1283.

The screw 50 can extend through the through hole 313 and be screwed into the screwing hole 1211.

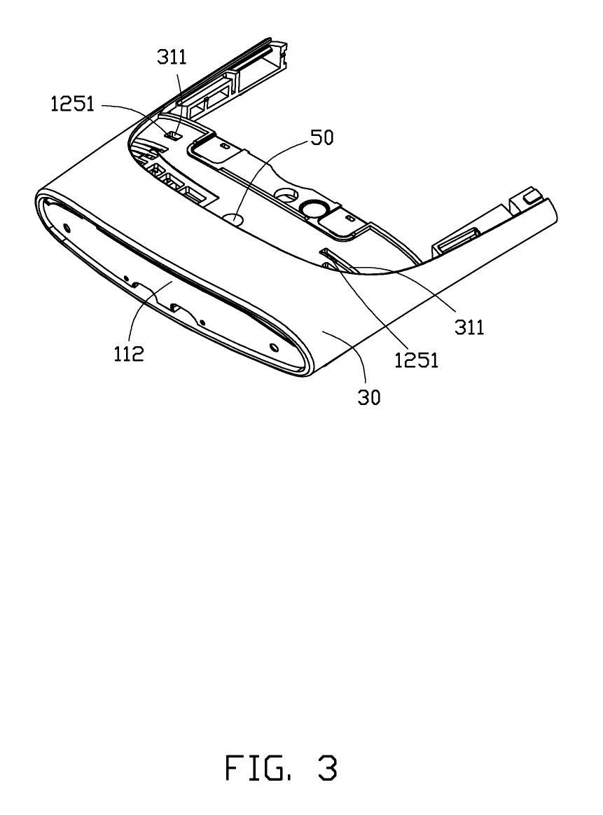

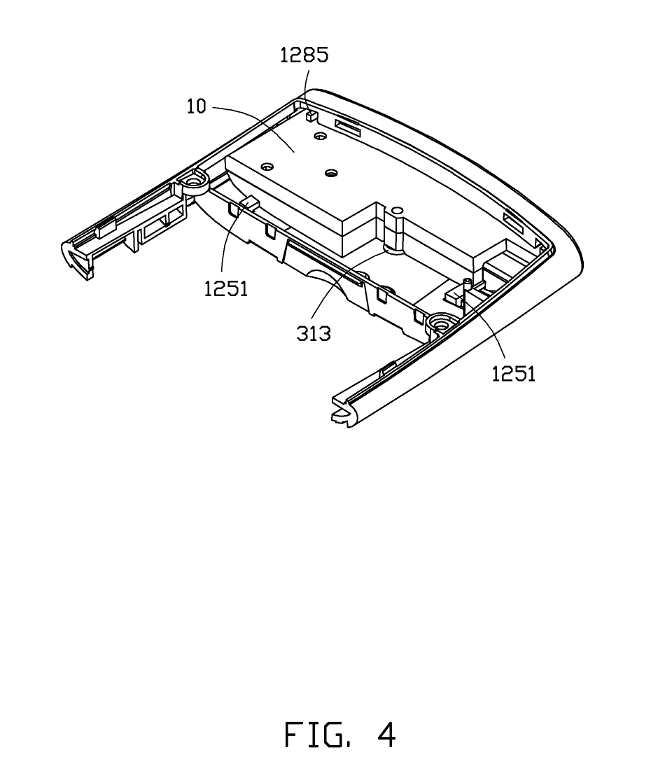

Referring to FIGS. 3 and 4, in assembly, the antenna 11 is attached to the base 12. The base 12 assembled with the antenna 11 is received in the receiving portion 35. The base 12 is slid toward the end portion 33 until the second mounting surface 123 is exposed from the opening 37. Then, the base 12 is slid away from the end portion 33 until the first protruding block 1281 and the second protruding blocks 1283 are respectively received in the first latching slot 335 and the second latching slots 337. Meanwhile, the latching members 1251 are engaged with the corresponding latching holes 311. Thus, the base 12 and the antenna 11 are assembled to housing 30. The first radiating portion 111 is sandwiched between the base 11 and the housing 30. The second radiating portion 112 is exposed from the opening 37, which can ensure radiation capability of the antenna 11. Finally, the screw 50 extends through the through hole 313 and is screwed into the screw hole 1211.

The antenna 11 can be connected to a circuit board (not shown) of the portable electronic device 100 by soldering a wire therebetween to transmitting/receiving signals and also can be disconnected from the circuit board by unsoldering the wire when the antenna module 10 needs to be disassembled from the housing 30.

The antenna module 10 is detachably assembled to the housing 30, which has the advantages of easy assembly. Additionally, the antenna module 10 can be easily disassembled from the housing 30 and replaced or repaired, because of the use of the latching member 1251, the first and second protruding blocks 1281, 1283, and screw 50 instead of an at least partially permanent method, such as surface mount technology.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna module assembled to a housing of a portable electronic device, the antenna module comprising:
a base including at least one latching member; and
an antenna attached to the base; wherein the base can be received in the housing, the at least one latching member engages with the housing to detachably assemble the base and the antenna to the housing.

2. The antenna module of claim 1, wherein the base includes a first mounting surface, a second mounting surface, a third mounting surface opposite to the second mounting surface, and a fourth mounting surface opposite to the first mounting surface, the antenna is attached to the first mounting surface and the second mounting surface, the at least one latching member protrudes from the third mounting surface.

3. The antenna module of claim 2, wherein the base further includes an extending wall perpendicularly extended from the fourth mounting surface, a first protruding block protrudes from the extending wall and parallel to the first mounting surface, the first protruding block can be received in the housing.

4. The antenna module of claim 2, wherein the first mounting surface defines a screw hole for fixedly assembling the base to the housing.

5. The antenna module of claim 2, wherein the antenna includes a first radiation portion attached to the first mounting surface and a second radiation portion attached to the second mounting surface, the first radiation portion is sandwiched between the base and the housing, the second radiation portion is exposed from the housing.

6. A portable electronic device, comprising:
a housing defining at least one latching hole;
an antenna module detachably assembled to the housing, the antenna module comprising:
a base including at least one latching member; and
an antenna attached to the base; wherein the base is received in the housing, the at least one latching member engages with the at least one latching hole to detachably assemble the base and the antenna to the housing.

7. The portable electronic device of claim 6, wherein the base includes a first mounting surface, a second mounting surface, a third mounting surface opposite to the second mounting surface, and a fourth mounting surface opposite to the first mounting surface, the at least one latching member protrudes from the third surface, the antenna is attached to the first mounting surface and the second mounting surface.

8. The portable electronic device of claim 7, wherein the base further includes an extending wall perpendicularly extended from the fourth mounting surface, a first protruding block protrudes from the extending wall, a U-shaped first portion protrudes from the end portion and forms a first latching slot, the first protruding block is received in the first latching slot.

9. The portable electronic device of claim 6, wherein the housing defines a through hole, the base defines a screw hole, the portable electronic device further includes an assembly member extends through the through hole and is screwed into the screw hole.

10. The portable electronic device of claim 9, wherein the assembly member is a screw.

11. The portable electronic device of claim 7, wherein a first radiation portion attached to the first mounting surface and a second radiation portion attached to the second mounting surface, the first radiation portion is sandwiched between the base and the housing, the second radiation portion is exposed from the housing.

12. The portable electronic device of claim 11, wherein the housing includes a bottom wall and an end portion opposite to the bottom, the housing defines an opening between the bottom wall and the end portion, the second radiation portion is exposed from the opening.
